(19) United States
(12) Patent Application Publication
(10) Pub. No.: US 2026/0369608 A1
(43) Pub. Date: Nov. 19, 2026

(54) METHOD FOR PREPARING NEGATIVE ELECTRODE COMPOSITION FOR SECONDARY BATTERY

(71) Applicant: SK ON CO., LTD., Seoul (KR)

(72) Inventors: Kwang Ho JEONG, Daejeon (KR); Young Gil CHOI, Daejeon (KR); Young Ju CHOI, Daejeon (KR); Byung Un HWANG, Daejeon (KR)

(21) Appl. No.: 19/710,394

(22) Filed: Jun. 17, 2026

Related U.S. Application Data
(63) Continuation-in-part of application No. PCT/KR2025/000403, filed on Jan. 8, 2025.

(30) Foreign Application Priority Data
Jan. 8, 2024 (KR) 10-2024-0002922
Dec. 30, 2024 (KR) 10-2024-0201408

(51) Int. Cl. H01M 4/62; C09J 101/28; H01M 4/02; H01M 4/133; H01M 4/587; H01M 10/0525

(52) U.S. Cl. CPC H01M 4/622; C09J 101/286; H01M 4/133; H01M 4/587; H01M 10/0525; H01M 2004/027

(57) ABSTRACT

According to exemplary embodiments of the present disclosure, a method for preparing an anode composition for a secondary battery includes mixing a first binder including at least one of carboxymethylcellulose including an acyclic hemiacetal functional group and a salt thereof, and a second binder including at least one of carboxymethylcellulose and a salt thereof not including the acyclic hemiacetal functional group, wherein the first and second binders each have a weight-average molecular weight greater than 300,000 g/mol and less than 3,500,000 g/mol.

### CROSS-REFERENCE TO RELATED APPLICATIONS

This application is a Bypass Continuation-in-part Application of PCT/KR2025/000403 filed on Jan. 8, 2025, which claims priority to Korean Patent Application No. 10-2024-0002922 filed Jan. 8, 2024, and No. 10-2024-0201408 filed Dec. 30, 2024, the disclosure of which is incorporated herein by reference in its entirety.

### TECHNICAL FIELD

The disclosure of the present application relates to a method for preparing a negative electrode (hereinafter, referred to as an anode) composition for a secondary battery, an anode for a secondary battery prepared using the same, and a secondary battery including the anode.

### BACKGROUND ART

Secondary batteries are batteries capable of being repeatedly charged and discharged, and have been widely applied as power sources for portable electronic communication devices such as camcorders, mobile phones, and laptop PCs with the development of information, communication, and display industries. In addition, recently, battery packs including secondary batteries have been developed and applied as power sources for eco-friendly vehicles such as electric vehicles.

Examples of secondary batteries may include a lithium secondary battery, a nickel-cadmium battery, and a nickel-metal hydride battery. Among these, the lithium secondary battery has been actively developed and applied due to its high operating voltage, high energy density per unit weight, and advantages in charging speed and weight reduction.

Recently, as the application scope of secondary batteries has expanded, the development of manufacturing methods for secondary battery anodes with higher reliability and process stability has been actively pursued. For example, the resistance, adhesion strength, and cycle life characteristics of the secondary battery and the anode may degrade depending on the order of raw material input and the type of raw material used in the manufacturing process of the anode.

### SUMMARY OF INVENTION

### Problems to be Solved by Invention

According to an aspect of the present disclosure, a method for preparing an anode composition for a secondary battery having improved dispersibility, stability and adhesion, and reduced resistance may be provided.

According to an aspect of the present disclosure, an anode for a secondary battery having improved stability and cycle life characteristics and reduced resistance may be provided.

According to an aspect of the present disclosure, a secondary battery having improved stability and cycle life characteristics and reduced resistance may be provided.

### Means for Solving Problems

A method for preparing an anode composition for a secondary battery according to embodiments of the present disclosure includes mixing a first binder including at least one of carboxymethylcellulose including an acyclic hemiacetal functional group and a salt thereof, and a second binder including at least one of carboxymethylcellulose and a salt thereof not including the acyclic hemiacetal functional group, wherein the first and second binders each have a weight-average molecular weight greater than 300,000 g/mol and less than 3,500,000 g/mol.

In some embodiments, the first binder and the second binder may be mixed in a weight ratio of 10:90 to 90:10.

In some embodiments, the first binder and the second binder may be mixed in a weight ratio of 20:80 to 80:20.

In some embodiments, the first binder and the second binder may be mixed in a powder state.

In some embodiments, the first and second binders may each have a viscosity of 550 cP to 14,500 cP.

In some embodiments, the method may further include mixing a first solvent after mixing the first and second binders and kneading the mixture to form a first preliminary composition having a solid content of 50% by weight to 75% by weight.

In some embodiments, the method may further include mixing a second solvent after forming the first preliminary composition to form a second preliminary composition having a solid content of 40% by weight to 65% by weight.

In some embodiments, the method may further include, during formation of the second preliminary composition, mixing a third binder together with the second solvent to form the second preliminary composition, or after mixing the second solvent, mixing the third binder to form a third preliminary composition.

In some embodiments, the first binder may include a carboxycellulose compound including a repeating unit represented by Formula 1 below, and the second binder may not include a carboxycellulose compound including a repeating unit represented by Formula 1 below.

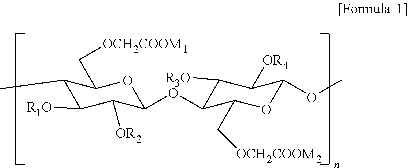

In Formula 1, M₁ and M₂ are each independently Na or Li, at least one of R₁ to R₄ is a group represented by Formula 2 below, and the remaining groups are each independently H or a group represented by Formula 2 below, and n is an integer.

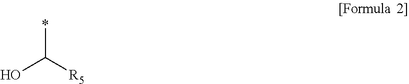

In Formula 2, R₅ is —CHO, —CH₂CHO, —COCH₃, or —CH₂COCH₃, and *— represents a bonding site bonded to oxygen.

In some embodiments, in Formula 2, R₅ may be —CHO or —COCH₃.

In some embodiments, the second binder powder may include a cellulose compound including a repeating unit represented by Formula 3 below.

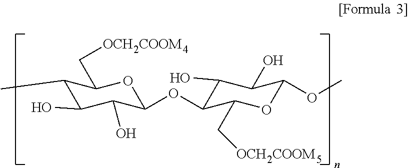

In Formula 3, M₄ and M₅ are each independently Na or Li, and n is an integer.

In some embodiments, an anode active material in a powder form may be mixed together with the first and second binders, and the anode active material may include at least one of natural graphite, artificial graphite, and a silicon-based active material.

In some embodiments, the first and second solvents may each independently include at least one selected from the group consisting of water, purified water, deionized water, distilled water, ethanol, isopropanol, methanol, acetone, n-propanol, and t-butanol.

An anode for a secondary battery according to embodiments of the present disclosure includes: an anode current collector; and an anode active material layer disposed on at least one surface of the anode current collector and formed from the above-described anode composition prepared by the method for preparing an anode composition for a secondary battery.

A secondary battery according to embodiments of the present disclosure includes: the above-described anode for a secondary battery; and a cathode disposed opposite the anode.

### Advantageous Effects

According to an embodiment of the present disclosure, an anode composition for a secondary battery having improved dispersibility, stability and adhesion, and reduced resistance may be prepared.

According to an embodiment of the present disclosure, the cycle life characteristics and output characteristics of an anode for a secondary battery prepared using the anode composition may be improved.

According to an embodiment of the present disclosure, the cycle life characteristics and output characteristics of a secondary battery including the anode may be improved.

The method for preparing the anode composition for a secondary battery, the anode, and the secondary battery of the present disclosure may be widely applied in green technology fields including electric vehicles, battery charging stations, and renewable energy systems using batteries, such as photovoltaics and wind power generation. The method for preparing the anode composition for a secondary battery, the anode, and the secondary battery of the present disclosure may be used in eco-friendly electric vehicles and hybrid vehicles to suppress air pollution and greenhouse gas emissions, thereby contributing to mitigating climate change.

### BRIEF DESCRIPTION OF DRAWINGS

FIG. 1 is a schematic flowchart for describing a method for preparing an anode composition for a secondary battery according to exemplary embodiments.

FIG. 2 is a schematic flowchart for describing a method for preparing an anode composition for a secondary battery according to other exemplary embodiments.

FIGS. 3 and 4 are a schematic plan view and a cross-sectional view, respectively, illustrating a secondary battery according to exemplary embodiments.

### MODE FOR CARRYING OUT INVENTION

Embodiments of the present disclosure provide a method for preparing an anode composition for a secondary battery (hereinafter, also abbreviated as “anode composition”). Embodiments of the present disclosure also provide an anode composition prepared using the method for preparing the anode composition, an anode for a secondary battery, and a secondary battery manufactured using the anode composition.

Hereinafter, embodiments of the present disclosure will be described in detail. However, the embodiments are merely illustrative, and the present disclosure is not limited to the specific embodiments described as examples.

### <Method for Preparing Anode Composition>

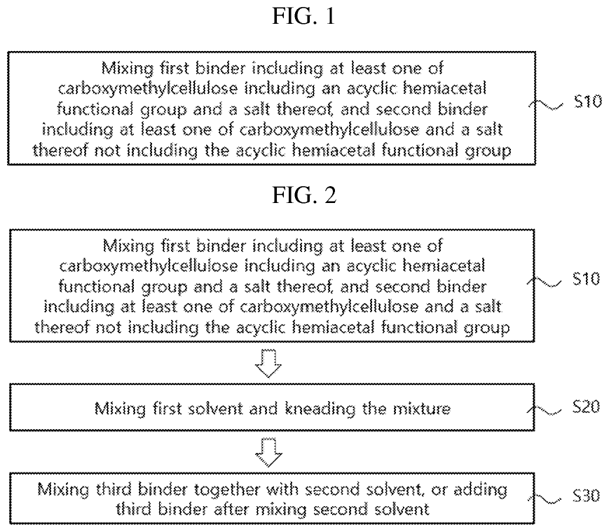

FIG. 1 is a schematic flowchart for describing a method for preparing an anode composition for a secondary battery according to exemplary embodiments.

The method for preparing the anode composition for a secondary battery includes mixing a first binder including at least one of carboxymethylcellulose including an acyclic hemiacetal functional group and a salt thereof, and a second binder including at least one of carboxymethylcellulose and a salt thereof not including the acyclic hemiacetal functional group (step S10).

The hemiacetal functional group refers to a group formed by an acyclic hemiacetal reaction of an aldehyde compound with at least one free hydroxyl group contained in carboxymethylcellulose or a salt thereof, and including a carbon having one hydroxyl group and one ether bond (—O—).

The first and second binders have a weight-average molecular weight greater than 300,000 g/mol and less than 3,500,000 g/mol.

Accordingly, the dispersibility among active materials within the anode composition is improved, which may improve the internal resistance and capacity characteristics of the anode and secondary battery manufactured therefrom.

The first binder has a faster dissolution rate when mixed with a solvent, thereby better dispersing the anode active materials, while the second binder has a relatively slower dissolution rate, which may further improve the stability of the prepared anode composition.

In addition, if the weight-average molecular weight of the first and second binders is too low, the dissolution rate becomes too fast, reducing the stability of the anode composition; conversely, if the weight-average molecular weight is too high, the dissolution rate becomes too slow, which may cause agglomeration among the anode active materials.

The first binder powder may include a product formed by performing an acyclic hemiacetal reaction (hereinafter, also abbreviated as a hemiacetal reaction) between at least one of free hydroxyl groups (—OH) of carboxymethylcellulose (CMC) and/or a salt thereof and an aldehyde compound. The metal included in the salt may be an alkali metal, for example, lithium, sodium, or calcium.

Specifically, the free hydroxyl group reacts with a —CHO group of the aldehyde compound to form one hydroxyl group and one ether bond (—O—) directly bonded to the same carbon.

A group including a carbon on which one hydroxyl group and one ether bond (—O—) are formed by the hemiacetal reaction may be defined as a hemiacetal functional group.

That is, the product may be carboxymethylcellulose and/or a salt thereof in which the hydroxyl group participating in the hemiacetal reaction is substituted with the hemiacetal functional group.

The first binder powder may include carboxymethylcellulose and/or a salt thereof in a form including a hemiacetal functional group derived from a hydroxyl group that participated in the hemiacetal reaction.

Compared to a composition using only CMC and/or a salt thereof in which the hydroxyl group is not substituted with the above-described hemiacetal functional group, the anode composition according to embodiments of the present disclosure may include a compound including the hemiacetal functional group, thereby more effectively improving the dispersibility of the anode active materials within the anode composition by means of repulsive force between ether bonds. For example, the dispersibility of the anode active materials may be improved due to changes in intermolecular interactions resulting from the introduction of the hemiacetal functional group. Accordingly, the cycle life characteristics and low-resistance characteristics of a secondary battery including an anode to which the anode composition prepared by the preparation method is applied may be improved.

For example, the carboxymethylcellulose including the hemiacetal functional group and/or a salt thereof may be prepared by mixing an aldehyde compound with CMC and/or a salt thereof etherified solely by a carboxymethyl group and/or a salt thereof and heating the mixture. The aldehyde compound may include a monoaldehyde compound and/or a dialdehyde compound. The aldehyde compound may include, for example, glyoxal, methyl glyoxal, etc.

The carboxymethylcellulose including the hemiacetal functional group or a salt thereof may be represented, for example, by Formula A below.

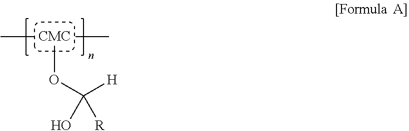

In Formula A, the CMC denotes a repeating unit constituting a main chain of carboxymethylcellulose or a salt thereof, and the functional group attached to the CMC denotes a hemiacetal functional group. The R may be, for example, an alkyl group or an alkyl group including an aldehyde group or a ketone group at a terminal position.

In some embodiments, the first binder may include a carboxycellulose compound including a repeating unit represented by Formula 1 below, and the second binder may not include a carboxycellulose compound including the repeating unit represented by Formula 1 below.

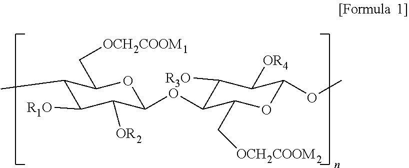

In Formula 1, M₁ and M₂ are each independently Na or Li, at least one of R₁ to R₄ is a group represented by Formula 2 below, and the remaining groups are each independently H or a group represented by Formula 2 below, and n is an integer.

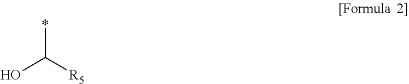

In Formula 2, R₅ is —CHO, —CH₂CHO, —COCH₃, or —CH₂COCH₃, and *— represents a bonding site bonded to oxygen.

In some embodiments, in Formula 2, R₅ may be —CHO or —COCH₃.

In some embodiments, the hemiacetal functional group may be a group represented, for example, by Formula A-1 or A-2 below.

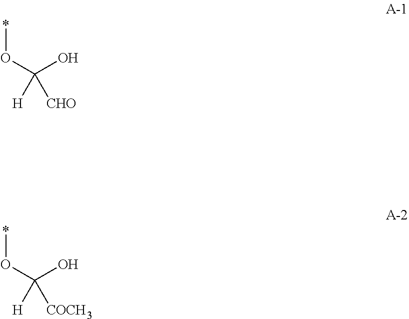 [SMILES: *OC(O)C=O ; *OC(O)C(C)=O]

In Formula A-1 or A-2, *— represents a bonding site where the hemiacetal functional group is bonded to the main chain of carboxymethylcellulose or a salt thereof, and is the same as the position where the free hydroxyl group was bonded prior to the hemiacetal reaction.

Accordingly, the first binder powder may include a compound including a repeating unit represented by Formula 1 in which any one, two, three, or four of R₁ to R₄ in Formula 1 are represented as a group in Formula 2.

M¹ and M₂ may be the same as each other.

In Formula 1, M₁ and M₂ in-OCH₂COOM₁ and —OCH₂COOM₂ may exist in the form of carboxylates formed by ionic bonding, respectively, and may exist in the forms of —OCH₂COO⁻M₁⁺ and OCH₂COO⁻M₂⁺.

The n may be, for example, 300 to 15,000 or 500 to 10,000.

In some embodiments, any one or two of R₁ to R₄ may be groups represented by Formula 2, and the remaining groups may be H.

In some embodiments, at least one of R₂ and R₄ may be a group represented by Formula 2, and the remaining groups may be H.

In some embodiments, the first binder powder may include a compound in which R₂ of R₁ to R₄ in Formula 1 is a group represented by Formula 2, and the remaining groups are H. The first binder powder may be, for example, a compound in which R₂ of R₁ to R₄ is a group represented by Formula 2, and the remaining groups are H.

In some embodiments, the first binder powder may include a compound in which R₂ of R₁ to R₄ is a group represented by Formula 2 and the remaining groups are H; and a compound in which R₄ of R₁ to R₄ is a group represented by Formula 2 and the remaining groups are H.

The compound including the repeating unit represented by Formula 1 may be, for example, a compound represented by Formula 1-1 below, but is not limited thereto.

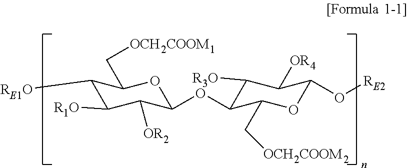

In Formula 1-1, M₁, M₂, R₁ to R₄, and n refer to those described above in Formula 1. R_{E1} and R_{E2} are each independently H or CH₂COOM₃, M₃ is Na or Li, and n is an integer. For example, R_{E1} may be hydrogen and R_{E2} may be CH₂COOM₃.

As a non-limiting example, M₁ to M₃ may be the same as one another.

In some embodiments, the second binder powder may include a cellulose compound including a repeating unit represented by Formula 3 below:

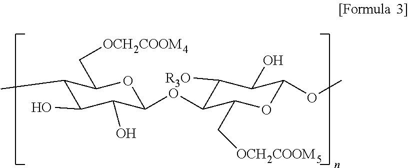

In Formula 3, M₄ and M₅ are Na or Li, and n is an integer. The n may be, for example, 300 to 15,000 or 500 to 10,000.

The compound including the repeating unit represented by Formula 3 may be, for example, a compound represented by Formula 3-1 below.

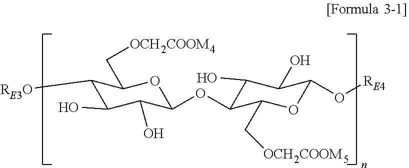

In Formula 3-1, M₄ and M₅ are each independently Na or Li, either R_{E3} or R_{E4} is H and the other is CH₂COOM₆, M₆ is Na or Li, and n is an integer. The n may be, for example, 300 to 15,000 or 500 to 10,000. For example, R_{E3} may be H and R_{E4} may be CH₂COOM₆.

As a non-limiting example, M₄ to M₆ may be the same as one another.

In one embodiment, the first binder may consist of at least one of carboxymethylcellulose including an acyclic hemiacetal functional group and a salt thereof, and the second binder may consist of at least one of carboxymethylcellulose and a salt thereof not including the acyclic hemiacetal functional group.

In some embodiments, the mixing of the first and second binders may be performed using a mixer, for example, an electrically-driven automatic mixer may be used as the mixer. For example, a mixer manufactured by Primix may be used as the mixer. As a non-limiting example, the mixer may be a 2,000 L class PD mixer, a Planetary Despa & Mixer, etc.

The mixer may be driven at a constant speed by varying the maximum driving current until the preparation of the anode slurry is completed. For example, the mixer may be operated at a constant rotational speed, and variations in the driving current generated during preparation of the slurry may be monitored.

In some embodiments, the first binder and the second binder may be mixed in a powder state.

The first and second binders may be introduced into the mixer in a solid state. The first and second binder powders may be introduced into the mixer separately, rather than in the form of a pre-mixed binder solution. Accordingly, the solvent shock phenomenon, in which swelling occurs on the surface of aggregates formed by the agglomeration of the first binder powder and prevents the first solvent from penetrating, may be further suppressed. As a result, the dispersibility of the anode active material and the first and second binders, as well as the cycle life characteristics of the secondary battery, may be further improved, and the internal resistance may be reduced. For example, the introduction of the first solvent may be performed 1 to 20 seconds after the introduction of the anode active material powder and the first and second binder powders has been completed.

In some embodiments, the first binder and the second binder may be mixed in a weight ratio of 10:90 to 90:10.

In some embodiments, the first binder and the second binder may be mixed in a weight ratio of 20:80 to 80:20, for example, in a weight ratio of 30:70 to 70:30 or 40:60 to 60:40. Accordingly, the stability of the anode composition may be ensured while improving the dispersibility of the anode active materials within the anode composition.

In some embodiments, the first and second binders may each have a viscosity of 550 cP to 14,500 cP, for example, 2,000 cP to 10,000 cP or 3,000 cP to 9,000 cP. The viscosity refers to the viscosity measured in an aqueous solution at a concentration of 1.2 wt %. The viscosity may be measured, for example, at room temperature. In this case, an aqueous solution with a concentration of 1.2 wt % may be formed by dissolving the first binder powder or the second binder powder in water at a concentration of 1.2 wt % each.

In some embodiments, the first and second binders may each have a weight-average molecular weight of 500,000 g/mol to 3,000,000 g/mol, 1,200,000 g/mol to 2,700,000 g/mol, or 1,500,000 g/mol to 2,500,000 g/mol. Accordingly, the dissolution rate of the first binder powder may be controlled so that it does not become too fast or the dissolution rate of the second binder powder does not become too slow, thereby further improving the dispersibility of the anode active materials within the anode composition and sufficiently ensuring the stability of the anode composition.

FIG. 2 is a schematic flowchart for describing a method for preparing an anode composition for a secondary battery according to other exemplary embodiments.

In some embodiments, the method may further include mixing a first solvent after mixing the first and second binders and kneading the mixture to form a first preliminary composition having a solid content of 50 wt % to 75 wt % (step S20).

In some embodiments, the method may further include mixing a second solvent after the formation of the first preliminary composition to form a second preliminary composition having a solid content of 40 wt % to 65 wt %.

In some embodiments, the method may further include, during formation of the second preliminary composition, mixing a third binder with the second solvent to form the second preliminary composition, or after mixing the second solvent, mixing the third binder to form a third preliminary composition (step S30).

The third binder may include a styrene-butadiene-rubber (SBR)-based binder, a styrene-acrylate-based binder, a polyacrylic acid-based binder, a poly(3,4-ethylenedioxythiophene) (PEDOT)-based binder, etc. These may be used alone or in combination of two or more thereof.

The third binder may be introduced in various forms including a solid form and a liquid form, and the form thereof is not particularly limited.

In some embodiments, where other components are not further mixed, the second preliminary composition or the third preliminary composition may be an anode composition prepared by the preparation method.

The anode active material powder (hereinafter, also abbreviated as ‘anode active material’) may include a material capable of adsorbing and desorbing lithium ions. For example, as the anode active material, carbon-based materials such as crystalline carbon, amorphous carbon, carbon composites, or carbon fibers, etc.; lithium metal; a lithium alloy; a silicon (Si)-containing material or a tin (Sn)-containing material may be used. These may be used alone or in combination of two or more thereof thereof. The amorphous carbon may include hard carbon, soft carbon, coke, mesocarbon microbead (MCMB), mesophase pitch-based carbon fiber (MPCF) or the like.

The crystalline carbon may include graphite-based carbon such as natural graphite, artificial graphite, graphitized coke, graphitized MCMB, graphitized MPCF or the like.

The lithium metal may include pure lithium metal and/or lithium metal having a protective layer formed thereon for suppressing dendrite growth and the like. In one embodiment, a lithium metal-containing layer deposited or coated on the anode current collector may be used as the anode active material layer. In one embodiment, a lithium thin-film layer may be used as the anode active material layer.

Elements contained in the lithium alloy may include aluminum, zinc, bismuth, cadmium, antimony, silicon, lead, tin, gallium or indium, etc. These elements may be used alone or in combination of two or more thereof.

The silicon-containing material may provide more increased capacity characteristics. The silicon-containing material may include Si, SiOₓ (0<x<2), metal-doped SiOₓ (0<x<2), silicon-carbon composites, etc.

The metal may include lithium and/or magnesium, and the metal-doped SiOx (0<x<2) may include a metal silicate.

In some embodiments, an anode active material in a powder form may be mixed with the first and second binders, and the anode active material may include at least one of natural graphite, artificial graphite, and a silicon-based active material.

For example, a ratio of the total content of the natural graphite and/or artificial graphite to the content of the silicon-based active material in the anode active material may be 90:10 to 99:1 or 95:5 to 99:1. This may be expressed as follows.

$$\frac{Total content of natural graphite and / or artificial graphite}{Content of silicon - based active material} = 90 / 10 to 99 / 1$$

In some embodiments, the anode active material may include the natural graphite and the SiOₓ (0<x<2).

In some embodiments, the first solvent may begin to be introduced before the introduction of the anode active material powder and the first and second binder powders is completed. For example, the first solvent may begin to be introduced together from the point when three-quarters of the introduction of the first and second binder powders has been completed, but is not limited thereto.

In some embodiments, the first and second solvents may each independently include at least one selected from the group consisting of water, purified water, deionized water, distilled water, ethanol, isopropanol, methanol, acetone, n-propanol, and t-butanol.

In some embodiments, the first and second solvents may be the same as each other.

As a non-limiting example, additional components such as a conductive material, a thickener, and a dispersant that may be further added to the anode composition may be introduced into the mixer at any time.

The solid content or viscosity of the anode composition may be controlled according to the technical purpose by adjusting the amount of the above-described components introduced.

The solid content of the anode composition may be, for example, 40 wt % to 65 wt %, 45 wt % to 63 wt %, 50 wt % to 61 wt %, or 52 wt % to 60 wt %.

For example, based on the total content of the solids included in the anode composition, the total amount of the anode active material may be appropriately adjusted to a range of 80 wt % to 98.9 wt %, the total amount of the binder to a range of 1.0 wt % to 10 wt %, for example, 1.1 wt % to 10 wt %, and the total amount of other components such as the conductive material to a range of 0.1 wt % to 10 wt %.

The anode composition may have a viscosity at 23 °C of, for example, 6,000 cP to 15,000 cP, 7,000 cP to 13,000 cP, 8,000 cP to 11,000 cP, 8,500 cP to 10,000 cP, or 9,000 cP to 9,500 cP.

### <Anode for Secondary Battery and Secondary Battery>

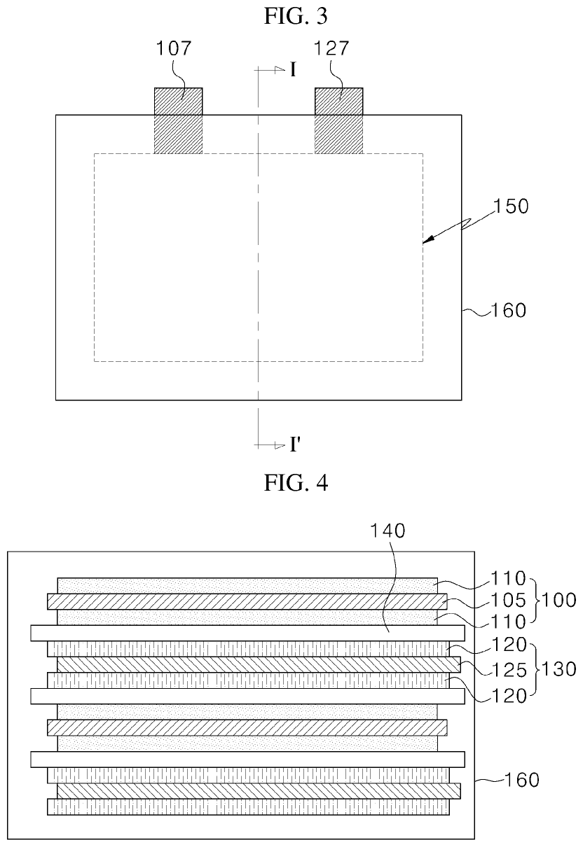

FIGS. 3 and 4 are a schematic plan view and a schematic cross-sectional view, respectively, illustrating a secondary battery according to exemplary embodiments. For example, FIG. 4 is a cross-sectional view taken along line I-I′ of FIG. 3 in a thickness direction of the battery.

The structures illustrated in FIGS. 3 and 4 are examples for convenience of description, and the structure of the secondary battery according to the embodiments of the present disclosure is not limited thereto.

Referring to FIGS. 3 and 4, the secondary battery may include an anode 130 fabricated using the above-described anode composition and a cathode 100 disposed opposite the anode 130.

The anode 130 may be formed from the anode composition prepared by the above-described preparation method.

For example, a method for fabricating an anode for a secondary battery including the above-described preparation method may be provided. The method for fabricating the anode for the secondary battery may include applying the above-described anode composition to at least one surface of an anode current collector 125, followed by drying and roll-pressing.

The anode 130 may be formed by applying the anode composition to at least one surface of the anode current collector 125, followed by drying and roll-pressing.

The cathode 100 may include a cathode current collector 105 and a cathode active material layer 110 formed on at least one surface of the cathode current collector 105.

The cathode current collector 105 may include stainless steel, nickel, aluminum, titanium, or an alloy thereof. The cathode current collector 105 may also include aluminum or stainless steel surface-treated with carbon, nickel, titanium or silver. For example, the cathode current collector 105 may have a thickness of 10 μm to 50 μm.

The cathode active material layer 110 may include a cathode active material. The cathode active material may include a compound capable of reversibly intercalating and deintercalating lithium ions.

According to exemplary embodiments, the cathode active material may include a lithium-nickel metal oxide. The lithium-nickel metal oxide may further include at least one of cobalt (Co), manganese (Mn), and aluminum (Al).

In some embodiments, the cathode active material or the lithium-nickel metal oxide may include a layered structure or a crystal structure represented by Formula 4 below.

LiₓNiₐM_{b}O_{2+z} [Formula 4]

In Formula 4, x, a, b and z may satisfy 0.9≤x≤1.2, 0.5≤a≤0.99, 0.01≤b≤0.5, and 0.5≤z≤0.1. As described above, M may include Co, Mn and/or Al.

The chemical structure represented by Formula 4 indicates a bonding relationship among elements included in the layered structure or the crystal structure of the cathode active material, and does not exclude the presence of additional elements. For example, M includes Co and/or Mn, and Co and/or Mn may be provided as main active elements of the cathode active material together with Ni. Here, it should be understood that Formula 4 is provided to express the bonding relationship between the main active elements, and is a formula encompassing the introduction and substitution of additional elements.

In one embodiment, the cathode active material may further include auxiliary elements which are added to the main active elements, in order to enhance chemical stability thereof or the layered structure/crystal structure. The auxiliary element may be incorporated into the layered structure/crystal structure together with the main active elements to form bonds, and it should be understood that this case is also included within the chemical structure range represented by Formula 4.

The auxiliary element may include, for example, at least one selected from the group consisting of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P and Zr. The auxiliary element may also act, for example, as an auxiliary active element that contributes to the capacity/output activity of the cathode active material together with Co or Mn, such as Al.

For example, the cathode active material or the lithium-nickel metal oxide may include a layered structure or a crystal structure represented by Formula 4-1 below.

LiₓNiₐM1_{b1}M2_{b2}O_{2+z} [Formula 4-1]

In Formula 4-1, M₁ may include Co, Mn and/or Al. M₂ may include the above-described auxiliary element. In Formula 4-1, x, a, b1, b2 and z may satisfy 0.9≤x≤1.2, 0.5≤a≤0.99, 0.01≤b1+b2≤0.5, and −0.5≤z≤0.1.

The cathode active material may further include a coating element or a doping element. For example, elements which are substantially the same as or similar to the above-described auxiliary elements may be used as the coating element or the doping element. For example, the above-described elements may be used alone or in combination of two or more thereof as the coating elements or the doping elements.

The coating element or the doping element may be present on the surface of the lithium-nickel metal oxide particles, or may penetrate through the surface of lithium-nickel metal composite oxide particles to be incorporated into the bonding structure represented by Formula 4 or Formula 4-1 above.

The cathode active material may include a nickel-cobalt-manganese (NCM)-based lithium oxide. In this case, an NCM-based lithium oxide with an increased content of nickel may be used.

Nickel may serve as a transition metal associated with the output and capacity of the lithium secondary battery. Therefore, as described above, by employing a high-nickel-content (high-Ni) composition in the cathode active material, a high-capacity cathode and a high-capacity lithium secondary battery may be provided.

However, as the Ni content increases, the long-term storage stability and cycle life stability of the cathode or the secondary battery may be relatively reduced, and side reactions with the electrolyte may also increase. Nevertheless, according to exemplary embodiments, by including Co while maintaining electrical conductivity, and including Mn to improve cycle stability and capacity retention, both properties can be enhanced.

The content of Ni (e.g., a mole fraction of nickel based on the total molar amount of nickel, cobalt and manganese) in the NCM-based lithium oxide may be 0.5 or more, 0.6 or more, 0.7 or more, or 0.8 or more. In some embodiments, the content of Ni may be 0.8 to 0.95, 0.82 to 0.95, 0.83 to 0.95, 0.84 to 0.95, 0.85 to 0.95, or 0.88 to 0.95.

In some embodiments, the cathode active material may include a lithium cobalt oxide-based active material, a lithium manganese oxide-based active material, a lithium nickel oxide-based active material, or a lithium iron phosphate (LFP)-based active material (e.g., LiFePO₄).

In some embodiments, the cathode active material may include, for example, an Li-rich layered oxide (LLO)/over-lithiated oxide (OLO)-based active material, an Mn-rich-based active material, or a Co-less active material, each having a chemical structure or a crystal structure represented by Formula 5. These may be used alone or in combination of two or more thereof.

p[Li₂MnO₃]·(1−p)[Li_{q}JO₂] [Formula 5]

In Formula 5, p and q may satisfy 0<p<1 and 0.9≤q≤1.2, and J may include at least one element selected from Mn, Ni, Co, Fe, Cr, V, Cu, Zn, Ti, Al, Mg and B.

The cathode active material may be mixed in a solvent to prepare a cathode slurry. The cathode slurry may be coated onto at least one surface of the cathode current collector 105, then dried and roll-pressed to prepare the cathode active material layer 110. The coating may include processes such as gravure coating, slot die coating, simultaneous multilayer die coating, imprinting, doctor blade coating, dip coating, bar coating or casting or the like. The cathode active material layer 110 may further include a binder, and optionally may further include a conductive material, a thickener or the like.

As the solvent, N-methyl-2-pyrrolidone (NMP), dimethylformamide, dimethylacetamide, N,N-dimethylaminopropylamine, ethylene oxide, tetrahydrofuran, and the like may be used.

The binder may include polyvinylidene fluoride (PVDF), poly(vinylidene fluoride-co-hexafluoropropylene), polyacrylonitrile, polymethylmethacrylate, acrylonitrile butadiene rubber (NBR), polybutadiene rubber (BR), styrene-butadiene rubber (SBR) and the like. These may be used alone or in combination of two or more thereof.

In one embodiment, a PVDF-based binder may be used as the cathode binder. In this case, the amount of binder for forming the cathode active material layer 110 may be decreased and the amount of the cathode active material may be relatively increased. Accordingly, the output characteristics and capacity characteristics of the secondary battery may be improved.

The conductive material may be added to the cathode active material layer 110 in order to enhance the conductivity thereof and/or the mobility of lithium ions or electrons. For example, the conductive material may include carbon-based conductive materials such as graphite, carbon black, acetylene black, Ketjen black, graphene, carbon nanotubes (CNTs), vapor-grown carbon fibers (VGCF), or carbon fibers; and/or metal-based conductive materials such as tin, tin oxide, and titanium oxide; as well as perovskite materials such as LaSrCoO₃, and LaSrMnO₃. These may be used alone or in combination of two or more thereof.

The cathode slurry may further include a thickener and/or a dispersant. In one embodiment, the cathode slurry may include a thickener such as carboxymethyl cellulose (CMC).

An anode composition may be prepared by the preparation method according to exemplary embodiments.

The anode 130 may include the anode current collector 125 and an anode active material layer 120 disposed on at least one surface of the anode current collector 125 and formed using the anode composition prepared by the preparation method according to exemplary embodiments. The anode composition prepared by the preparation method according to exemplary embodiments may have the form of an anode slurry. The anode active material layer 120 may be formed by applying the above-described anode composition on at least one surface of the anode current collector 125, followed by drying, for example, by applying the above-described anode composition, followed by drying and roll-pressing.

For example, the anode current collector 125 may include copper foil, nickel foil, stainless steel foil, titanium foil, nickel foam, copper foam, or a polymer substrate coated with a conductive metal. These may be used alone or in combination of two or more thereof. For example, the anode current collector 125 may have a thickness of 10 μm to 50 μm.

The anode active material layer 120 may include the above-described anode active material. For example, the anode active material may include a plurality of anode active material particles.

The above-described anode composition may be coated or deposited on the anode current collector 125, and then dried and roll-pressed to prepare the anode active material layer 120. The coating may include processes such as gravure coating, slot die coating, simultaneous multilayer die coating, imprinting, doctor blade coating, dip coating, bar coating or casting or the like. The anode active material layer 120 may further include a binder, and optionally may further include a conductive material, a thickener or the like.

The above-described materials that can be used when preparing the cathode 100 as the binder, conductive material and thickener may also be used for the anode.

In exemplary embodiments, a separator 140 may be interposed between the cathode 100 and the anode 130. The separator 140 may be configured to prevent an electrical short-circuit between the cathode 100 and the anode 130, and to allow the flow of ions. For example, the separator may have a thickness of 10 μm to 20 μm.

For example, the separator 140 may include a porous polymer film or a porous nonwoven fabric.

The porous polymer film may include a polyolefin-based polymer such as an ethylene polymer, a propylene polymer, an ethylene/butene copolymer, an ethylene/hexene copolymer, or an ethylene/methacrylate copolymer, etc. These may be used alone or in combination of two or more thereof.

The porous nonwoven fabric may include glass fibers having a high melting point, polyethylene terephthalate fibers, etc.

The separator 140 may also include a ceramic-based material. For example, inorganic particles may be coated on the polymer film or dispersed within the polymer film to improve heat resistance.

The separator 140 may have a single-layer or multilayer structure including the above-described polymer film and/or non-woven fabric.

According to exemplary embodiments, an electrode cell may be defined by the cathode 100, the anode 130 and the separator 140, and a plurality of electrode cells may be stacked to form, for example, a jelly roll type electrode assembly 150. For example, the electrode assembly 150 may be formed by winding, stacking, z-folding, or stack-folding the separator 140.

The electrode assembly 150 may be accommodated in a case 160 together with the electrolyte to define a lithium secondary battery. According to exemplary embodiments, a non-aqueous electrolyte may be used as the electrolyte.

The non-aqueous electrolyte may include a lithium salt as an electrolyte and an organic solvent, the lithium salt may be represented by, for example, Li⁺X⁻, and as an anion (X⁻) of the lithium salt, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅ PF, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻, and the like may be exemplified.

As the organic solvent, for example, propylene carbonate (PC), ethylene carbonate (EC), butylene carbonate, diethyl carbonate (DEC), dimethyl carbonate (DMC), ethyl methyl carbonate (EMC), methyl propyl carbonate, ethylpropyl carbonate, dipropyl carbonate, vinylene carbonate, methyl acetate (MA), ethyl acetate (EA), n-propylacetate (n-PA), 1,1-dimethylethyl acetate (DMEA), methyl propionate (MP), ethyl propionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (DEGDME), dimethoxyethane, tetrahydrofuran (THF), 2-methyltetrahydrofuran, ethyl alcohol, isopropyl alcohol, dimethyl sulfoxide, acetonitrile, diethoxyethane, sulfolane, γ-butyrolactone, propylene sulfite, and the like may be used. These may be used alone or in combination of two or more thereof.

The non-aqueous electrolyte may further include an additive. The additive may include, for example, a cyclic carbonate compound, a fluorine-substituted carbonate compound, a sultone compound, a cyclic sulfate compound, a cyclic sulfite compound, a phosphate compound, a borate compound and the like. These may be used alone or in combination of two or more thereof.

The cyclic carbonate compound may include vinylene carbonate (VC), vinyl ethylene carbonate (VEC), etc.

The fluorine-substituted carbonate compound may include fluoroethylene carbonate (FEC), etc.

The sultone compound may include 1,3-propane sultone, 1,3-propene sultone, 1,4-butane sultone, etc.

The cyclic sulfate compound may include 1,2-ethylene sulfate, 1,2-propylene sulfate, etc.

The cyclic sulfite compound may include ethylene sulfite, butylene sulfite, etc.

The phosphate compound may include lithium difluoro bis(oxalato)phosphate, lithium difluorophosphate, etc.

The borate compound may include lithium bis(oxalate) borate, etc.

In some embodiments, a solid electrolyte may be used in place of the above-described non-aqueous electrolyte. In this case, the lithium secondary battery may be manufactured in the form of an all-solid-state battery. In addition, a solid electrolyte layer may be disposed between the cathode 100 and the anode 130 in place of the above-described separator 140.

The solid electrolyte may include a sulfide-based electrolyte. As a non-limiting example, the sulfide-based electrolyte may include Li₂S—P₂S₅, Li₂S—P₂S₅—LiCl, Li₂S—P₂S₅—LiBr, Li₂S—P₂S₅—LiCl—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are positive numbers, Z is Ge, Zn or Ga), Li₂S—GeS₂, Li₂S—SiS₂—Li₃PO₄, Li₂S—SiS₂-LiₚMO_{q} (p and q are positive numbers, M is P, Si, Ge, B, Al, Ga or In), Li₇₋ₓPS₆-xClₓ (0≤x≤2), Li₂₋ₓPS₆₋ₓBrₓ (0≤x≤2), Li₇₋ₓPS₆₋ₓIₓ (0≤x≤2), etc. These may be used alone or in combination of two or more thereof.

In one embodiment, the solid electrolyte may include an oxide-based amorphous solid electrolyte, such as, for example, Li₂O—B₂O₃—P₂O₅, Li₂O—SiO₂, Li₂O—B₂O₃, Li₂O—B₂O₃—ZnO, etc.

As shown in FIGS. 3 and 4, electrode tabs (a cathode tab and an anode tab) may protrude from the cathode current collector 105 and the anode current collector 125, respectively, which belong to respective electrode cells, and may extend to one side of the case 160. The electrode tabs may be welded together with the one side of the case 160 to form electrode leads (a cathode lead 107 and an anode lead 127) that extend or are exposed to the outside of the case 160.

The lithium secondary battery may be manufactured, for example, in a cylindrical, prismatic, pouch, or coin type using a can.

The above-described embodiments of the present disclosure include the following aspects and may be implemented through at least one of the following aspects.

A method for preparing an anode composition for a secondary battery according to a first aspect of the present disclosure includes mixing a first binder including at least one of carboxymethylcellulose including an acyclic hemiacetal functional group and a salt thereof, and a second binder including at least one of carboxymethylcellulose and a salt thereof not including the acyclic hemiacetal functional group, wherein the first and second binders each have a weight-average molecular weight greater than 300,000 g/mol and less than 3,500,000 g/mol.

In the first aspect, according to a second aspect, the first binder and the second binder may be mixed in a weight ratio of 10:90 to 90:10.

In the second aspect, according to a third aspect, the first binder and the second binder may be mixed in a weight ratio of 20:80 to 80:20.

In any one of the first to third aspects, according to a fourth aspect, the first binder and the second binder may be mixed in a powder state.

In any one of the first to fourth aspects, according to a fifth aspect, the first and second binders may each have a viscosity of 550 cP to 14,500 cP.

In any one of the first to fifth aspects, according to a sixth aspect, the method may further include mixing a first solvent after mixing the first and second binders and kneading the mixture to form a first preliminary composition having a solid content of 50% by weight to 75% by weight.

In the sixth aspect, according to a seventh aspect, the method may further include mixing a second solvent after forming the first preliminary composition to form a second preliminary composition having a solid content of 40% by weight to 65% by weight.

In the seventh aspect, according to an eighth aspect, the method may further include, during formation of the second preliminary composition, mixing a third binder together with the second solvent to form the second preliminary composition, or after mixing the second solvent, mixing the third binder to form a third preliminary composition.

In any one of the first to eighth aspects, according to a ninth aspect, the first binder may include a carboxycellulose compound including a repeating unit represented by Formula 1, and the second binder may not include a carboxycellulose compound including a repeating unit represented by Formula 1 below.

In the ninth aspect, according to a tenth aspect, in Formula 2, R₅ may be —CHO or —COCH₃.

In any one of the first to tenth aspects, according to an eleventh aspect, the second binder powder may include a cellulose compound including a repeating unit represented by Formula 3.

In any one of the first to eleventh aspects, according to a twelfth aspect, an anode active material in a powder form may be mixed together with the first and second binders, and the anode active material may include at least one of natural graphite, artificial graphite, and a silicon-based active material.

In the seventh aspect, according to a thirteenth aspect, the first and second solvents may each independently include at least one selected from the group consisting of water, purified water, deionized water, distilled water, ethanol, isopropanol, methanol, acetone, n-propanol, and t-butanol.

An anode for a secondary battery according to a fourteenth aspect of the present disclosure includes: an anode current collector; and an anode active material layer disposed on at least one surface of the anode current collector and formed from the anode composition prepared by the method for preparing an anode composition according to any one of the first to thirteenth aspects.

A secondary battery according to a fifteenth aspect of the present disclosure includes: the anode for a secondary battery according to the fourteenth aspect; and a cathode disposed opposite the anode.

Hereinafter, embodiments of the present disclosure will be further described with reference to specific experimental examples. However, the examples and comparative examples included in the experimental examples are provided merely for illustrative purposes of the present disclosure and are not intended to limit the scope of the appended claims. It will be apparent to those skilled in the art that various changes and modifications can be made within the scope and spirit of the present disclosure, and such changes and modifications are to be regarded as falling within the scope of the appended claims.

### PREPARATIVE EXAMPLE

### Preparative Example 1

250 g of CMC-Na including a repeating unit represented by Formula 3 (weight-average molecular weight: 1,500,000, degree of substitution (DS): 0.9), 3.5 g of methylglyoxal, and 0.5 g of oxalic acid were added to 500 g of an ethanol solution, then the mixture was stirred at 60 °C for 180 minutes, and dried to prepare a first binder powder (Compound a).

The Compound a included a repeating unit represented by Formula 1, wherein in Formula 1, M₁ and M₂ were Na, R₂ of R₁ to R₄ was a group represented by Formula 2 and the remaining groups were H, and in Formula 2, R₅ was —COCH₃.

### Preparative Example 2

A first binder powder (Compound b) was prepared in the same manner as in Preparative Example 1, except that an equal amount of glyoxal was added instead of methylglyoxal.

The Compound b included a repeating unit represented by Formula 1, wherein in Formula 1, M₁ and M₂ were Na, R₂ of R₁ to R₄ was a group represented by Formula 2 and the remaining groups were H, and in Formula 2, R₅ was —CHO.

### Preparative Example 3

A first binder powder (Compound c) was prepared in the same manner as in Preparative Example 1, except that 250 g of CMC-Na (weight-average molecular weight: 300,000, degree of substitution (DS): 0.9) was used.

### Preparative Example 4

A first binder powder (Compound d) was prepared in the same manner as in Preparative Example 1, except that 250 g of CMC-Na (weight-average molecular weight: 3,500,000, degree of substitution (DS): 0.9) was used.

### EXAMPLES

### Example 1

### (1) Preparation of Anode Composition

The Compound a was used as a first binder powder, and CMC-Na (weight-average molecular weight: 1,500,000, degree of substitution (DS): 0.9), which was used in Preparative Example 1, was used as a second binder powder. The Compound a was a compound including a repeating unit represented by Formula 1, and CMC-Na was a compound including a repeating unit represented by Formula 3.

The planetary mixer of a mixer (a 2,000 L class PD mixer manufactured by Primix) was set and maintained at a maximum driving speed, and natural graphite as an anode active material, carbon black as a conductive material, and the first binder powder and the second binder powder were introduced into the mixer.

Then, water was introduced into the mixer as a first solvent and the mixture was kneaded to form the first preliminary composition.

Then, SBR was introduced into the mixer, followed by the introduction of water, to prepare an anode composition in the form of a slurry.

Based on the total solid content of the prepared anode composition, a weight ratio of the natural graphite, the carbon black, the first binder powder, the second binder powder, and the SBR was 96.8:0.5:0.24:0.96:1.5. The total solid content of the anode composition was 54 wt %.

### Examples 2 to 8 and Comparative Examples 1 to 5

Anode compositions were prepared in the same manner as in Example 1, except that the weight ratio, viscosity, and weight-average molecular weight of the first and second binders were changed as shown in Table 1 below.

TABLE 1

| | | | Weight | First binder and | | | |
|---|---|---|---|---|---|---|---|
| | | | ratio | second binder | | | |
| | | | of first | | | Weight- | |
| | | | binder to | | | average | |
| | First | Second | second | | | molecular | |
| | binder | binder | binder | Viscosity | | weight | |
| Example 1 | Compound a | CMC-Na | 20:80 | 3,000 | cP | 1,500,000 | g/mol |
| Example 2 | Compound a | CMC-Na | 40:60 | 3,000 | cP | 1,500,000 | g/mol |
| Example 3 | Compound a | CMC-Na | 50:50 | 3,000 | cP | 1,500,000 | g/mol |
| Example 4 | Compound a | CMC-Na | 60:40 | 3,000 | cP | 1,500,000 | g/mol |
| Example 5 | Compound a | CMC-Na | 80:20 | 3,000 | cP | 1,500,000 | g/mol |
| Example 6 | Compound b | CMC-Na | 50:50 | 3,000 | cP | 1,500,000 | g/mol |
| Example 7 | Compound a | CMC-Na | 10:90 | 3,000 | cP | 1,500,000 | g/mol |
| Example 8 | Compound a | CMC-Na | 90:10 | 3,000 | cP | 1,500,000 | g/mol |
| Comparative | — | CMC-Na | 0:100 | 3,000 | cP | 1,500,000 | g/mol |
| Example 1 | | | | | | | |
| Comparative | Compound a | — | 100:0 | 3,000 | cP | 1,500,000 | g/mol |
| Example 2 | | | | | | | |
| Comparative | Compound c | CMC-Na | 50:50 | 500 | cP | 300,000 | g/mol |
| Example 3 | | | | | | | |
| Comparative | Compound d | CMC-Na | 50:50 | 15,000 | cP | 3,500,000 | g/mol |
| Example 4 | | | | | | | |
| Comparative | — | CMC-Na | 0:100 | 200,000 | cP | 4,000,000 | g/mol |
| Example 5 | | | | | | | |

### (2) Manufacture of Secondary Battery

A secondary battery was manufactured as follows using the anode compositions according to the above-described examples and comparative examples.

The anode composition was coated onto a copper current collector, and then dried and roll-pressed to fabricate an anode.

A cathode composition in the form of a slurry was prepared by mixing LiNi_{0.8}Co_{0.1}Mn_{0.1}O₂ as a cathode active material, carbon black as a conductive material, and PVDF as a binder in a mass ratio of 95:3:2. The cathode slurry was coated onto an aluminum current collector, and then dried and roll-pressed to fabricate a cathode.

Forty-three cathodes and forty-four anodes were notched to a predetermined size and stacked, then an electrode cell was fabricated by interposing a separator (polyethylene, thickness: 25 μm) between the cathode and the anode. Thereafter, tab parts of the cathode and the anode were welded, respectively. The assembly of the welded cathode/separator/anode was placed into a pouch, and three sides of the pouch were sealed, leaving one side open for electrolyte injection. At this time, the portion having the electrode tab was included in the sealed part. After injecting the electrolyte through the electrolyte injection side, the remaining electrolyte injection side was also sealed, and the cell was allowed to be impregnated for 12 hours or more to prepare a secondary battery.

A solution, prepared by dissolving a 1M LiPF₆ solution in a mixed solvent of EC/EMC (25/75; volume ratio), and further adding 1 wt % of vinylene carbonate (VC), and 0.5 wt % of 1,3-propenesultone (PRS) based on the total weight of the solution, was used as the electrolyte.

The manufactured lithium secondary battery was pre-charged at a current of 5 A corresponding to 0.25 C for 36 minutes. After 1 hour, degassing was performed, followed by aging for 24 hours or more, and then formation charging-discharging was carried out (charging conditions: CC-CV 0.2 C 4.2 V 0.05 C cut-off; discharging conditions: CC 0.2 C 2.5 V cut-off).

### Experimental Examples

### (1) Measurement of Anode Adhesion Strength

The adhesion strength of the anodes of the above-described examples and comparative examples was measured through a 90° peel test. The measurement equipment used was the DS2-N model of IMADA.

Specifically, the anodes were cut to a length of 18 mm to prepare samples. A tape was attached to the samples, and the force (90°) required to peel off the tape was measured and expressed in units of N/18 mm.

The results thereof are shown in Table 2 below.

### (2) Measurement of Internal Resistance

The internal resistance of the secondary batteries of the above-described examples and comparative examples was measured using a 200A-class charge/discharger of Wonik PNE.

Specifically, the direct current internal resistance (DCIR) was measured by applying a current equivalent to 1 C for 10 seconds at a 50% state of charge (SOC).

The results thereof are shown in Table 2 below.

### (3) Evaluation of Capacity Retention

For the secondary batteries of the examples and comparative examples, charging (CC-CV 0.33 C 4.2 V 0.05 C cut-off) and discharging (CC 0.33 C 2.5 V cut-off) were each performed 800 times in a chamber maintained at 25 °C. The capacity retention was then evaluated by dividing the discharge capacity at the 800th cycle by the discharge capacity at the first cycle and multiplying by 100.

The results thereof are shown in Table 2 below.

### (4) Measurement of Weight-Average Molecular Weight

For each compound used as the first and second binder powders, the weight-average molecular weight was measured as follows by analyzing the gel permeation chromatograph (GPC)-treated samples using an EcoSEC HLC-8320 GPC of Tosoh.

In the sample treatment, the sample was prepared by filtering a solution in which the sample was completely dissolved through a 0.45 μm nylon filter without separate sample pretreatment.

The sample was analyzed under the following analysis equipment/conditions to measure the weight-average molecular weight of the binder compound.
i) Analyzer: Tosoh, EcoSEC HLC-8320 GPC
ii) Detector: RI detector
iii) Developing solution: 0.1 M NaNO₃
iv) Column: TSKgel GMPWxl (7.8 mm×300 mm)× 2
v) Temperature: 40 °C.
vi) Flow rate: 1 mL/min
vii) Sample injection volume: 200 μl, 0.5 mg/mL
viii) Standard material: polysaccharide
ix) Data processing software: EcoSEC software

The results thereof are shown in Table 2 below.

### (5) Measurement of Solid Content of Anode Composition

For the anode compositions of the examples and comparative examples, the weight of the anode composition was measured and the anode composition was dried in an oven.

The weight of the dried solid was measured.

The percentage of the value obtained by dividing the measured weight of the solid by the measured weight of the anode composition was calculated.

TABLE 2

| | Weight | | | | | |
|---|---|---|---|---|---|---|
| | ratio of | | | Evaluation result | | |
| | first | Weight- | | Adhesion | | |
| | binder to | average | | strength | Internal | Capacity |
| | second | molecular | | (N/18 | resistance | retention |
| | binder | weight | | mm) | (mΩ) | (%) |
| Example 1 | 20:80 | 1,500,000 | g/mol | 0.53 | 1.112 | 87.1 |
| Example 2 | 40:60 | 1,500,000 | g/mol | 0.51 | 1.043 | 89.0 |
| Example 3 | 50:50 | 1,500,000 | g/mol | 0.49 | 1.023 | 89.9 |
| Example 4 | 60:40 | 1,500,000 | g/mol | 0.45 | 0.995 | 91.2 |
| Example 5 | 80:20 | 1,500,000 | g/mol | 0.42 | 0.992 | 90.9 |
| Example 6 | 50:50 | 1,500,000 | g/mol | 0.49 | 1.022 | 89.7 |
| Example 7 | 10:90 | 1,500,000 | g/mol | 0.50 | 1.448 | 70.3 |
| Example 8 | 90:10 | 1,500,000 | g/mol | 0.35 | 1.244 | 72.8 |
| Comparative | 0:100 | 1,500,000 | g/mol | 0.53 | 1.561 | 60.8 |
| Example 1 | | | | | | |
| Comparative | 100:0 | 1,500,000 | g/mol | 0.32 | 1.523 | 61.1 |
| Example 2 | | | | | | |
| Comparative | 50:50 | 300,000 | g/mol | 0.33 | 1.620 | 60.2 |
| Example 3 | | | | | | |
| Comparative | 50:50 | 3,500,000 | g/mol | 0.63 | 1.593 | 68.6 |
| Example 4 | | | | | | |
| Comparative | 0:100 | 4,000,000 | g/mol | 0.64 | 1.63 | 60.2 |
| Example 5 | | | | | | |

Referring to Table 2, the adhesion strength and capacity retention were improved and the internal resistance was reduced in the secondary batteries according to the examples.

In the secondary batteries according to the comparative examples in which the anode composition contained the first binder alone or the second binder alone, or in which the first binder and the second binder were mixed but had a weight-average molecular weight of 300,000 g/mol or less or 3,500,000 g/mol or more, the capacity retention decreased to 68.6% or less, and the internal resistance increased to 1.523 mΩ or more.

In the secondary batteries according to Examples 1 to 6, in which the weight ratio of the first and second binders was 20:80 to 80:20, the capacity retention was further improved and the internal resistance was further reduced.

The anode compositions prepared in Comparative Examples 1 and 5 using only a second binder not including the hemiacetal functional group had significantly reduced dispersibility among active materials, resulting in a very low capacity retention and a very high internal resistance of the secondary batteries including the anode compositions. Even when using a compound having a high weight-average molecular weight as in Comparative Example 5, only the adhesion strength became too high, while the capacity retention and internal resistance of the secondary battery were still evaluated to be degraded.

In the anode composition prepared in Comparative Example 2 using only the first binder including a hemiacetal functional group, stability was reduced and the first binder acted as an impeding factor for Li insertion/extraction, etc., resulting in increased internal resistance and a low capacity retention.

In Comparative Example 3, in which the weight-average molecular weights of the first binder powder and the second binder powder were too small, slurry stability was reduced, causing a phenomenon similar to that of Comparative Example 2. As a result, the adhesive strength was reduced to a level similar to that of Comparative Example 2, and the internal resistance increased while the capacity retention decreased.

In Comparative Example 4, where the weight-average molecular weight of the first and second binder powders was too large, the dissolution rate in the solvent was too slow, preventing smooth dispersion among the active materials, causing a phenomenon similar to that of Comparative Example 1 to occur, resulting in increased internal resistance and a low capacity retention.

1. A method for preparing an anode composition for a secondary battery comprising mixing a first binder including at least one of carboxymethylcellulose including an acyclic hemiacetal functional group and a salt thereof, and a second binder including at least one of carboxymethylcellulose and a salt thereof not including the acyclic hemiacetal functional group,
wherein the first and second binders each have a weight-average molecular weight greater than 300,000 g/mol and less than 3,500,000 g/mol.

2. The method for preparing an anode composition for a secondary battery according to claim 1, wherein the first binder and the second binder are mixed in a weight ratio of 10:90 to 90:10.

3. The method for preparing an anode composition for a secondary battery according to claim 2, wherein the first binder and the second binder are mixed in a weight ratio of 20:80 to 80:20.

4. The method for preparing an anode composition for a secondary battery according to claim 1, wherein the first binder and the second binder are mixed in a powder state.

5. The method for preparing an anode composition for a secondary battery according to claim 1, wherein the first and second binders each have a viscosity of 550 cP to 14,500 cP.

6. The method for preparing an anode composition for a secondary battery according to claim 1, further comprising mixing a first solvent after mixing the first and second binders and kneading the mixture to form a first preliminary composition having a solid content of 50% by weight to 75% by weight.

7. The method for preparing an anode composition for a secondary battery according to claim 6, further comprising mixing a second solvent after forming the first preliminary composition to form a second preliminary composition having a solid content of 40% by weight to 65% by weight.

8. The method for preparing an anode composition for a secondary battery according to claim 7, further comprising, during formation of the second preliminary composition, mixing a third binder together with the second solvent to form the second preliminary composition, or after mixing the second solvent, mixing the third binder to form a third preliminary composition.

9. The method for preparing an anode composition for a secondary battery according to claim 1, wherein the first binder comprises a carboxycellulose compound including a repeating unit represented by Formula 1 below, and the second binder does not comprise a carboxycellulose compound including a repeating unit represented by Formula 1 below: 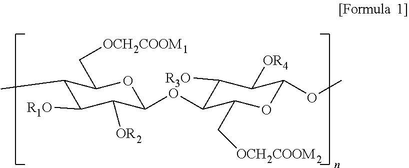
(in Formula 1, M₁ and M₂ are each independently Na or Li, at least one of R₁ to R₄ is a group represented by Formula 2 below, and the remaining groups are each independently H or a group represented by Formula 2 below, and n is an integer), and 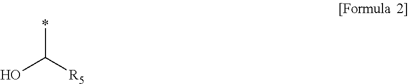
(in Formula 2, R₅ is —CHO, —CH₂CHO, —COCH₃, or —CH₂COCH₃, and *— represents a bonding site bonded to oxygen).

10. The method for preparing an anode composition for a secondary battery according to claim 9, wherein in Formula 2, R₅ is —CHO or —COCH₃.

11. The method for preparing an anode composition for a secondary battery according to claim 1, wherein the second binder powder comprises a cellulose compound including a repeating unit represented by Formula 3 below: 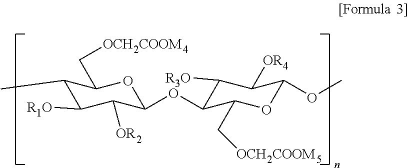
(in Formula 3, M₄ and M₅ are each independently Na or Li, and n is an integer).

12. The method for preparing an anode composition for a secondary battery according to claim 1, wherein an anode active material in a powder form is mixed together with the first and second binders, and the anode active material comprises at least one of natural graphite, artificial graphite, and a silicon-based active material.

13. The method for preparing an anode composition for a secondary battery according to claim 7, wherein the first and second solvents each independently comprise at least one selected from the group consisting of purified water, deionized water, distilled water, ethanol, isopropanol, methanol, acetone, n-propanol, and t-butanol.

14. An anode for a secondary battery comprising:
an anode current collector; and
an anode active material layer disposed on at least one surface of the anode current collector and formed from the anode composition prepared by the method for preparing an anode composition for a secondary battery according to claim 1.

15. A secondary battery comprising:
the anode for a secondary battery according to claim 14; and
a cathode disposed opposite the anode.
